(19) United States
(12) Patent Application Publication
(10) Pub. No.: US 2009/0020725 A1
(43) Pub. Date: Jan. 22, 2009

(54) FLUSH VALVE APPARATUS AND METHOD FOR FORMING A FRAME AND HOUSING FOR A FLUSH VALVE

(75) Inventors: Tuan Le, Diamond Bar, CA (US); Bryan Janish, Carlsbad, CA (US); Robert Collin, Lake Forest, CA (US); Bill DeKeyser, Rancho Santa Margarita, CA (US)

Correspondence Address: MYERS DAWES ANDRAS & SHERMAN, LLP, 19900 MACARTHUR BLVD., SUITE 1150, IRVINE, CA, 92612, US

(73) Assignee: Fluidmaster, Inc., San Juan Capistrano, CA (US)

(21) Appl. No.: 12/172,391

(22) Filed: Jul. 14, 2008

Related U.S. Application Data
(60) Provisional application No. 60/959,957, filed on Jul. 18, 2007.

(51) Int. Cl. F16K 27/00

(52) U.S. Cl. 251/356; 29/527.1

(57) ABSTRACT

A method of manufacturing a flush valve device is provided, including forming a mold for a first half and a second half of the flush valve device, performing injection molding on the mold, upon cooling, removing the first half and the second half from the mold, and forming the flush valve device by joining the first half and the second half.

### RELATED APPLICATIONS

This application relates to, claims priority from, and incorporates herein by reference, as if fully set forth, U.S. Provisional Patent Application Ser. No. 60/959,957, filed on Jul. 18, 2007 and entitled “APPARATUS FOR A FLUSH VALVE.”

### BACKGROUND OF THE INVENTION

1. Field of the Invention

The present invention relates generally to toilet flush valves and particularly to manufacturing a frame and housing for flush valves.

2. Description of Prior Art and Related Information

A flush valve frame and a flush valve housing that are formed in conventional manufacturing methods require multiple slides in an injection mold to form their respective complex geometries for functional purposes. Because of the flush valve frame and housing size and structure, the parts cannot be manufactured economically using an injection mold with multi-cavities.

### BRIEF SUMMARY OF THE INVENTION

One aspect of the invention provides a method of manufacturing a flush valve device including forming a mold for a first half and a second half of the flush valve device, performing injection molding on the mold, upon cooling, removing the first half and the second half from the mold, and forming the flush valve device by joining the first half and the second half.

In one embodiment of the invention, the device is a flush valve frame. In another embodiment of the invention, the device is a flush valve housing. In one embodiment of the invention, the liquid material is plastic material. In yet another embodiment of the invention includes coupling the first portion to the second portion comprises snap fitting a male portion of the first portion into a female portion of the second portion. In one embodiment of the invention coupling the first portion to the second portion comprises snap fitting a male portion of the second portion into a female portion of the first portion. In another embodiment coupling the first portion to the second portion comprises fastening the first portion to the second portion with fasteners. In still another embodiment of the invention the first portion and the second portion are different. In one embodiment of the invention the first portion and the second portion are identical.

Another aspect of the invention provides manufacturing a flush valve device. The method comprising forming a mold for a first half and a second half of the flush valve device, performing injection molding on the mold, upon cooling, removing the first half and the second half from the mold, and forming the flush valve device by joining the first half and the second half.

In one embodiment of the invention, the device is a flush valve frame. In another embodiment of the invention the device is a flush valve housing. In yet another embodiment of the invention, joining the first half with the second half comprises snap fitting a male portion of the first half into a female portion of the second half. In still another embodiment of the invention joining the first half to the second half comprises snap fitting a male portion of the second half into a female portion of the first half. In one embodiment of the invention joining the first half to the second half comprises fastening the first half to the second half with fasteners. In another embodiment of the invention the first half and the second half are different. In yet another embodiment of the invention the first half and the second half are identical.

Still another aspect of the invention provides a method for manufacturing a flush valve kit. The method comprising forming a first mold for a first half and a second half of the flush valve frame, forming a second mold for a first half and a second half of a flush valve housing, performing injection molding on the first mold and the second mold, upon cooling, removing the first half and the second half of the flush valve frame from the first mold, and removing the first half and the second half of the flush valve housing from the second mold, forming the flush valve frame by joining the first half and the second half of the flush valve frame together, and forming the flush valve housing by joining the first half and the second half of the flush valve housing together.

In one embodiment of the invention joining the first half with the second half of the flush valve frame comprises snap fitting a male portion of the first half into a female portion of the second half. In another embodiment of the invention joining the first half to the second half of the flush valve frame comprises snap fitting a male portion of the second half into a female portion of the first half. In yet another embodiment of the invention joining the first half to the second half of the flush valve housing comprises fastening the first half to the second half with fasteners. In still another embodiment of the invention includes packaging the flush valve frame and the flush valve housing together as a kit.

Another aspect of the invention provides a flush valve apparatus including a first half including a first coupling portion and a second half including a second coupling portion. The first half and the second half form a complete flush valve device.

In one embodiment of the invention the flush valve device is a flush valve frame. In another embodiment of the invention the flush valve device is a flush valve housing. In yet another embodiment of the invention the first coupling is a snap fitting a male portion and the second coupling is a snap fitting female portion. In still another embodiment of the invention the first coupling is a fastener and the second portion is a fastener receptacle.

Other aspects and advantages of the present invention will become apparent from the following detailed description, which, when taken in conjunction with the drawings, illustrate by way of example the principles of the invention.

The invention, now having been briefly summarized, may be better appreciated by the following detailed description.

### BRIEF DESCRIPTION OF THE DRAWINGS

FOR A FULLER UNDERSTANDING OF THE NATURE AND ADVANTAGES OF THE INVENTION, AS WELL AS A PREFERRED MODE OF USE, REFERENCE SHOULD BE MADE TO THE FOLLOWING DETAILED DESCRIPTION READ IN CONJUNCTION WITH THE ACCOMPANYING DRAWINGS, IN WHICH:

FIG. 1 is a view of a first half and a second half of a flush valve frame separated in accordance with an embodiment of the invention;

FIG. 2 is a view of a first half and a second half of a flush valve frame joined together in accordance with an embodiment of the invention;

FIG. 3 is a view of a first half and a second half of a flush valve housing separated in accordance with an embodiment of the invention;

FIG. 4 is a view of a first half and a second half of a flush valve housing joined in accordance with an embodiment of the invention; and

FIG. 5 is a block diagram of a method of manufacturing in accordance with an embodiment of the invention.

### DETAILED DESCRIPTION OF THE PREFERRED EMBODIMENTS

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

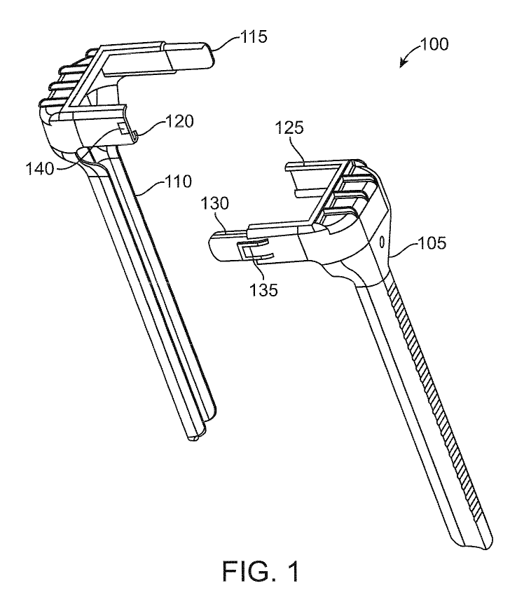

FIG. 1 illustrates a first half 105 and a second half 110 of a frame 100 for a flush valve used in toilet tanks connected to a bowl. The first half 105 and second half 110 are preferably formed by injection molding. The first half 105 and second half 110 can be formed in either separate molds or one mold including forms for both the first half 105 and the second half 110 injection fluid can be any material or combination of injection molding liquid used to form a rigid structure, such as plastics, etc. Hot or cold injection molding can be used to form first half 105 and second half 110.

When the injection material has hardened or cooled, the first half 105 and second half 110 are then removed from the mold or molds. The first half 105 and second half 110 can then be packaged as separate parts, which reduces the packaging footprint from a whole flush valve frame, or joined together and packaged as one single unit.

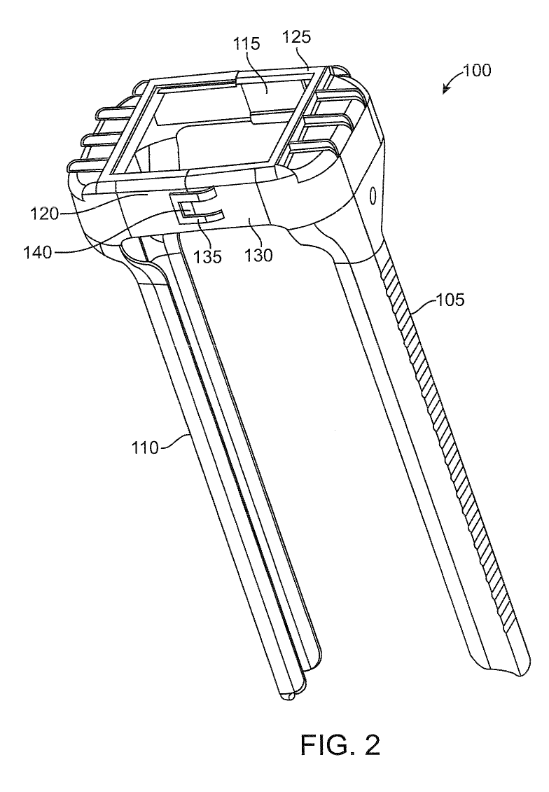

In one embodiment, the first half 105 includes a male interlocking portion 130 and a female interlocking portion 125. In this embodiment, the second half 110 includes a male interlocking portion 115 and a female interlocking portion 120. The interlocking portions (115, 120, 125, 130) fit together and lock from a locking means 135 and 140 on both sides of the frame halves (105 and 110). In this embodiment, the two halves are snap fit together to form a single flush valve frame 100, as illustrated in FIG. 2. In other embodiment, different means for joining the two halves 105 and 110 can be used, such as adhesives, fasteners, heat welding, etc.

In one embodiment, the first half 105 and second half 110 can be viewed as “mirror” images of each other. In another embodiment, the two halves are different from one another.

By injection molding the frame 100 in first half 105 and second half 110, the molds used are simpler and the manufacturing of frame 100 is less costly and more simple than typical flush valve frame molds that must be formed with multi-cavities due to the complex geometries.

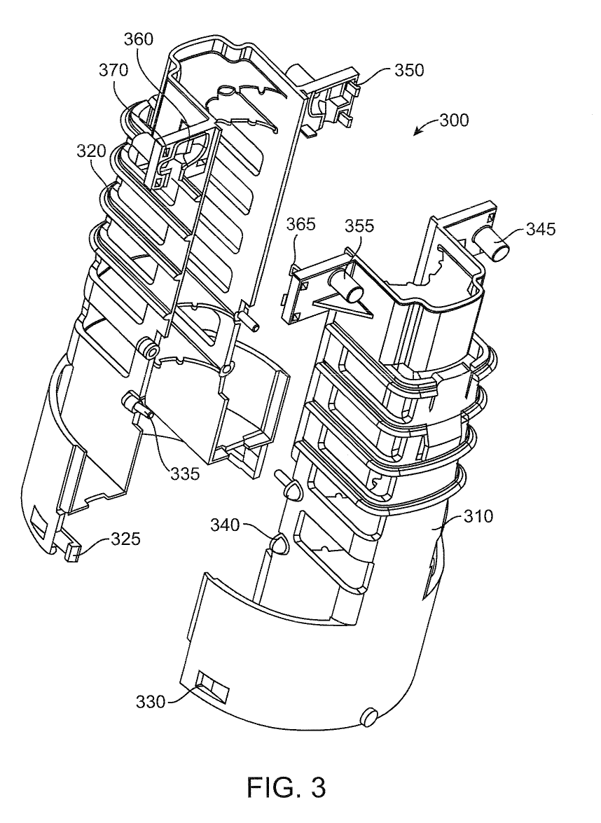

FIG. 3 illustrates a first half 310 and a second half 320 of a housing 300 for a flush valve used in toilet tanks connected to a bowl. The first half 310 and second half 320 are preferably formed by injection molding. The first half 310 and second half 320 can be formed in either separate molds or one mold including forms for both the first half 310 and the second half 320. Injection fluid can be any material or combination of injection molding liquid used to form a rigid structure, such as plastics, etc. Hot or cold injection molding can be used to form first half 310 and second half 320.

When the injection material has hardened or cooled, the first half 310 and second half 320 are then removed from the mold or molds. The first half 310 and second half 320 can then be packaged as separate parts, which reduces the packaging footprint from a whole flush valve housing, or joined together and packaged as one single unit.

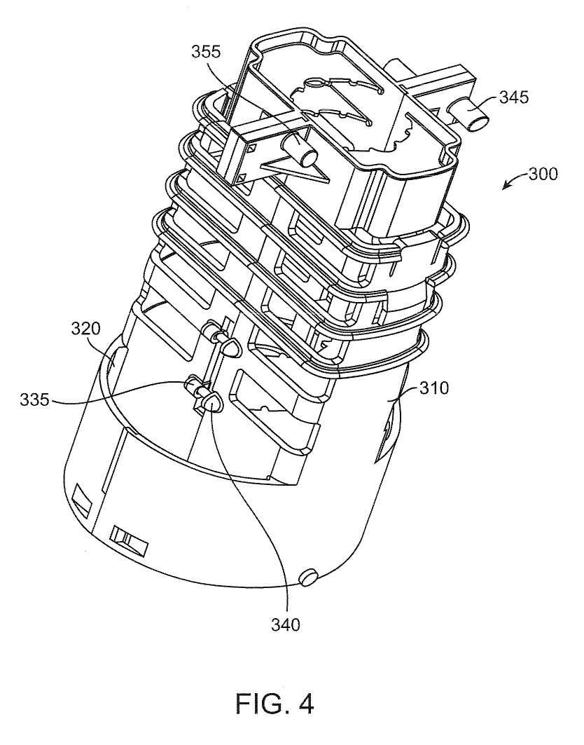

In one embodiment, the first half 310 includes a male interlocking portion 330 and a female interlocking portion 330. In this embodiment, the second half 320 includes a male interlocking portion 325 and a female interlocking portion 330. The interlocking portions fit together and lock on both sides of the housing halves (310 and 320). In this embodiment, the two halves 310, 320 are snap fit together to form a single flush valve housing 300, as illustrated in FIG. 4. Guides and other locking means, such as locking pairs 335 and 340, 345 and 350, 355 and 360, 365 and 370, etc. are used to snap fit the two halves 310 and 320 together to form a single flush valve housing 300. In other embodiment, different means for joining the two halves 310 and 320 can be used, such as adhesives, fasteners, heat welding, etc.

In one embodiment, the first half 310 and second half 320 can be viewed as “mirror” images of each other. In another embodiment, the two halves are different from one another.

By injection molding the housing 300 in first half 310 and second half 320 the molds used are simpler and the manufacturing of housing 300 is less costly and more simple than typical flush valve housing molds that must be formed with multi-cavities due to the complex geometries.

One or more molds can be formed to produce frame halves 105 and 110, and housing halves 310 and 320 together. In one embodiment, the frame 100 and housing 300 are packaged as a kit. In other embodiments, the frame 100 and housing 300 halves are packaged separately from one another.

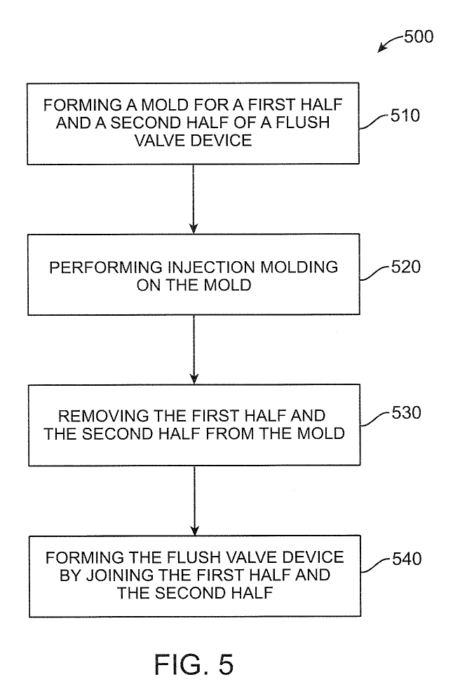

FIG. 5 illustrates a block diagram of a method of manufacturing a flush valve device in halves, such as frame 100 and housing 300. Process 500 begins with forming a mold for a first half and a second half of a flush valve device. In block 520 injection molding is performed using the formed mold. In block 530 the first half and second half of the flush valve device are removed from the mold. Before removing the two halves or single halves if separate molds are used, each half must be hardened or cooled so that the resulting half is hardened. In block 540 the two molded halves are then joined together as with the embodiments illustrated in FIGS. 1-4.

Advantageously, the embodiments provide manufacturing processes of injection molding two halves of a flush valve device, such as a frame and housing. The discussed embodiments reduce packaging costs, costs of forming a mold, less complex molds, etc. then flush valve devices that are manufactured from one mold to produce a one-piece device.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different elements, which are disclosed above even when not initially claimed in such combinations.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what incorporates the essential idea of the invention.

What is claimed is:

1. A method comprising:
forming a first mold for a first portion of a flush valve device;
forming a second mold for a second portion of the flush valve device;
injecting the first mold and the second mold with a liquid material;
upon hardening, removing the first portion from the first mold, and removing the second portion from the second mold; and
coupling the first portion with the second portion to form the flush valve device.

2. The method of claim 1, wherein the device is a flush valve frame.

3. The method of claim 1, wherein the device is a flush valve housing.

4. The method of claim 1, wherein the liquid material is plastic material.

5. The method of claim 1, wherein coupling the first portion to the second portion comprises snap fitting a male portion of the first portion into a female portion of the second portion.

6. The method of claim 5, wherein coupling the first portion to the second portion comprises snap fitting a male portion of the second portion into a female portion of the first portion.

7. The method of claim 1, wherein coupling the first portion to the second portion comprises fastening the first portion to the second portion with fasteners.

8. The method of claim 1, wherein the first portion and the second portion are different.

9. The method of claim 1, wherein the first portion and the second portion are identical.

10. A method of manufacturing a flush valve device, comprising:
forming a mold for a first half and a second half of the flush valve device;
performing injection molding on the mold;
upon cooling, removing the first half and the second half from the mold; and
forming the flush valve device by joining the first half and the second half.

11. The method of claim 10, wherein the device is a flush valve frame.

12. The method of claim 10, wherein the device is a flush valve housing.

13. The method of claim 1, wherein joining the first half with the second half comprises snap fitting a male portion of the first half into a female portion of the second half.

14. The method of claim 13, wherein joining the first half to the second half comprises snap fitting a male portion of the second half into a female portion of the first half.

15. The method of claim 10, wherein joining the first half to the second half comprises fastening the first half to the second half with fasteners.

16. The method of claim 10, wherein the first half and the second half are different.

17. The method of claim 10, wherein the first half and the second half are identical.

18. A method for manufacturing a flush valve kit, comprising:
forming a first mold for a first half and a second half of the flush valve frame;
forming a second mold for a first half and a second half of a flush valve housing;
performing injection molding on the first mold and the second mold;
upon cooling, removing the first half and the second half of the flush valve frame from the first mold, and removing the first half and the second half of the flush valve housing from the second mold;
forming the flush valve frame by joining the first half and the second half of the flush valve frame together; and
forming the flush valve housing by joining the first half and the second half of the flush valve housing together.

19. The method of claim 18, wherein joining the first half with the second half of the flush valve frame comprises snap fitting a male portion of the first half into a female portion of the second half.

20. The method of claim 19, wherein joining the first half to the second half of the flush valve frame comprises snap fitting a male portion of the second half into a female portion of the first half.

21. The method of claim 18, wherein joining the first half to the second half of the flush valve housing comprises fastening the first half to the second half with fasteners.

22. The method of claim 18, further comprising:
packaging the flush valve frame and the flush valve housing together as a kit.

23. A flush valve apparatus, comprising:
a first half including a first coupling portion; and
a second half including a second coupling portion,
wherein the first half and the second half form a complete flush valve device.

24. The apparatus of claim 23, wherein the flush valve device is a flush valve frame.

25. The apparatus of claim 23, wherein the flush valve device is a flush valve housing.

26. The apparatus of claim 23, wherein the first coupling is a snap fitting a male portion and the second coupling is a snap fitting female portion.

27. The apparatus of claim 23, wherein the first coupling is a fastener and the second portion is a fastener receptacle.
